(19) United States
(12) Patent Application Publication
(10) Pub. No.: US 2008/0200178 A1
(43) Pub. Date: Aug. 21, 2008

(54) METHOD FOR TRANSMITTING DATA AND CELLULAR SYSTEM USING THE SAME

(76) Inventor: Kojiro Hamabe, Tokyo (JP)

Correspondence Address: NEC CORPORATION OF AMERICA, 6535 N. STATE HWY 161, IRVING, TX, 75039, US

(21) Appl. No.: 11/964,344

(22) Filed: Dec. 26, 2007

(30) Foreign Application Priority Data
Feb. 21, 2007 (JP) 040141/2007

(51) Int. Cl. H04Q 7/20

(52) U.S. Cl. 455/452.1

(57) ABSTRACT

A cellular system where, in each of a plurality of cells, a base station transmits the same data to a plurality of mobile stations at a predetermined transmission rate, comprises an adjusting portion for adjusting a resource used for data transmission to make a resource consumption level equal to a predetermined threshold when the resource consumption level in the cell exceeds the predetermined threshold due to the data transmission, and a transmitting portion for performing the data transmission by using the adjusted resource.

### INCORPORATION BY REFERENCE

This application is based upon and claims the benefit of priority from Japanese patent applications No. 2007-040141, filed on Feb. 21, 2007, the disclosure of which is incorporated herein its entirety by reference.

### BACKGROUND OF THE INVENTION

1. Technical Field

The present invention relates to a method for transmitting data and a cellular system using the method, and particularly to a method for transmitting data of Multimedia Broadcast Multicast Service (MBMS).

2. Related Art

Services in a cellular system for transmitting the same data to a plurality of mobile stations are under study, and one of them is MBMS in Wideband-Code Division Multiple Access (W-CDMA) system. There are references concerning MBMS such as Japanese Patent Laid-Open No. 2006-254179, and 3GPP TS25.346 V.6.8.0 (2006-06), 3rd Generation Partnership Project; Technical Specification Group Radio Access Network; Introduction of the Multimedia Broadcast Multicast Service (MBMS) in the Radio Access Network (RAN); Stage 2 (Release 6).

A plurality of base stations exist in a cellular system of the W-CDMA system, and each base station forms one or more cells, and communicates with a mobile station in each of the cells. One radio frequency is allocated to each of the cells.

In MBMS, data is transmitted via a common channel, or data is transmitted by assigning a dedicated channel to each of a plurality of mobile stations, respectively. In the case using the common channel, Secondary Common Control Physical Channel (SCCPCH), which is a common channel, is set, and data is transmitted by using the SCCPCH.

Further, in an area where the MBMS service is provided, MBMS data is concurrently transmitted in many cells to which the same radio frequency is allocated. At this time, the mobile stations use a technique, i.e. so-called “Selective Combining” or “Soft Combining” that data transmitted from the plurality of cells is received to perform diversity combining, and thereby coverage of an area where MBMS data is receivable is enhanced.

In a cellular system such as the W-CDMA system, one cell is provided with, in addition to the MBMS service, the voice transmission service or the packet transmission service dedicated to a user, by using Dedicated Physical Channel (DPCH) which is a dedicated channel. Radio Network Controller (RNC), which is a radio network control system being in an upper layer than that of the base station, calculates a cell load, which is a load of each cell, according to traffic of the voice transmission service or the packet transmission service provided in each cell, and performs admission control to transmit MBMS data when the cell load is equal to or smaller than a predetermined threshold.

In addition, National Publication of International Patent Application No. 2005-525743 discloses a method for effectively using a radio resource when High Speed Downlink Shared Channel (HSDSCH) is used in High Speed Downlink Packet Access (HSDPA) system in a cellular system.

As described above, in an area where the MBMS service is provided, MBMS data is concurrently transmitted in many cells, and in a cell that is blocked from MBMS data transmission by the above admission control, MBMS data cannot be transmitted, and therefore a mobile station in this cell cannot receive MBMS data.

Here, referring to the technique disclosed in Japanese Patent Laid-Open No. 2006-254179 described above, there is disclosed a method that transmission power of MBMS data is controlled according to traffic of the voice service. Specifically, when the traffic of the voice service exceeds a threshold, the transmission power of MBMS data is changed to a reduced quantity by a constant ratio such as two-thirds of a normal transmission power.

However, using this method, when the admission control does not block MBMS data from being transmitted, or when the cell load slightly exceeds the threshold of the admission control, the transmission power of MBMS data is also reduced by the constant ratio, so that there is a problem that coverage of a receivable area of MBMS data is largely decreased. Further, even if the transmission power of MBMS data is reduced by the constant ratio, when the cell load slightly exceeds the threshold of the admission control, MBMS data cannot be also transmitted, and there is, just the same, a problem that coverage of a receivable area of MBMS data is largely decreased.

### SUMMARY

An object of the present invention is to provide a method for transmitting data by which MBMS data is transmitted to maximize an area where MBMS data is receivable, and a cellular system using the method.

A method for transmitting data according to the present invention is a method for transmitting data in a cellular system where, in each of a plurality of cells, a base station transmits the same data to a plurality of mobile stations at a predetermined transmission rate, the method including; adjusting a resource used for data transmission to make a resource consumption level equal to a predetermined threshold when the resource consumption level in the cell exceeds the predetermined threshold due to the data transmission; and performing the data transmission by using the adjusted resource.

A cellular system according to the present invention is a cellular system where, in each of a plurality of cells, a base station transmits the same data to a plurality of mobile stations at a predetermined transmission rate, the cellular system including; an adjusting portion for adjusting a resource used for data transmission to make a resource consumption level equal to a predetermined threshold when the resource consumption level in the cell exceeds the predetermined threshold due to the data transmission; and a transmitting portion for performing the data transmission by using the adjusted resource.

A program according to the present invention is a program for executing a method for transmitting data in a cellular system on a computer, in which, in each of a plurality of cells, a base station transmits the same data to a plurality of mobile stations at a predetermined transmission rate, the program including; a process of adjusting a resource used for data transmission to make a resource consumption level equal to a predetermined threshold when the resource consumption level in the cell exceeds the predetermined threshold due to the data transmission; and a process of performing the data transmission by using the adjusted resource.

### BRIEF DESCRIPTION OF THE DRAWINGS

FIG. 1 shows a configuration of a cellular system of a first exemplary embodiment of the present invention;

FIG. 2 is a functional block diagram of RNC in the first exemplary embodiment;

FIG. 3 is a flowchart illustrating MBMS data transmission procedures in the first exemplary embodiment;

FIG. 4 shows a configuration of a cellular system of a second exemplary embodiment of the present invention;

FIG. 5 shows an example of RB assignment in the second exemplary embodiment;

FIG. 6 is a functional block diagram of a base station in the second exemplary embodiment; and

FIG. 7 is a flowchart illustrating MBMS data transmission procedures in the second exemplary embodiment.

### EXEMPLARY EMBODIMENT

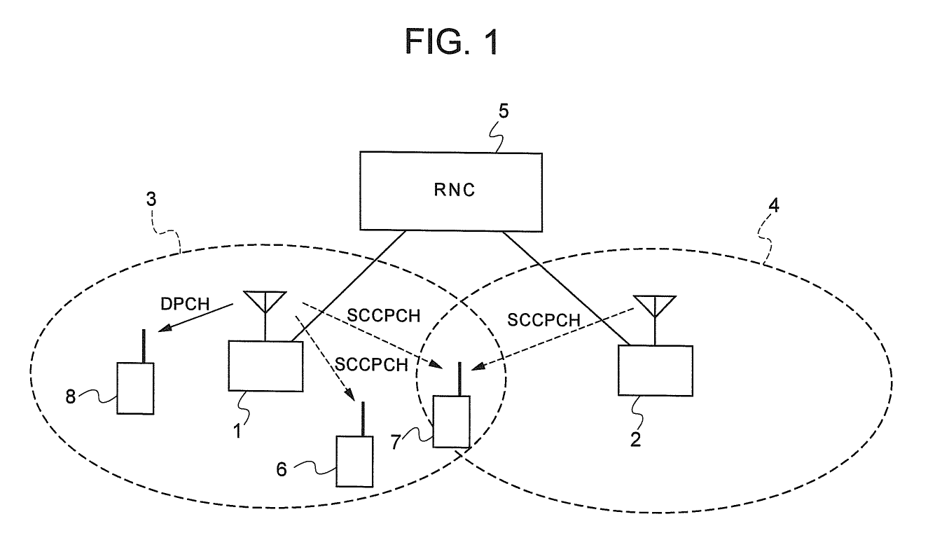

Next, an exemplary embodiment of the present invention will be described with reference to the accompanying drawings. FIG. 1 shows a configuration of a cellular system of a first exemplary embodiment of the present invention. The cellular system includes base stations 1 and 2, cells 3 and 4 that the base stations 1 and 2 cover, respectively, RNC 5 connected to the base stations 1 and 2, and mobile stations 6 to 8. The cellular system includes, aside from these, many base stations and mobile stations, but for simplicity, illustration thereof is omitted.

In the cellular system, assuming that the base stations 1 and 2 provide a plurality of the mobile stations with the voice transmission service or the packet transmission service by using a dedicated physical channel (DPCH) in the cells 3 and 4, respectively, and further transmit the same data (MBMS data) to the plurality of mobile stations by setting SCCPCH. The MBMS data is concurrently transmitted in all the cells 3 and 4 by using the same radio frequency. Further, the mobile station that can receive the MBMS data of the plurality of cells concurrently receives the MBMS data to perform diversity combining.

In FIG. 1, assuming that the mobile stations 6 and 7 receive the MBMS data transmitted by SCCPCH and the mobile station 8 receives DPCH. Among them, assuming that the mobile station 7 positioned near boundaries with the cells 3 and 4 receives the MBMS data transmitted in the cell 3 of the base station 1 and the cell 4 of the base station 2, and performs diversity combining. Further, though not shown, in this cellular system, the base stations transmit Common Pilot Channel (CPICH) by using constant power in each of the cells, and use CPICH to, for example, decide the cell where the mobile station communicates.

In this cellular system, when an MBMS data transmission request occurs, RNC 5 performs admission control based on a resource consumption level for each cell to decide whether data transmission is allowed or not. Hereinafter, this resource consumption level is called “cell load”, and the cell load will be described.

Communication via a dedicated physical channel (DPCH) occurs when a communication request is issued by each mobile station, and transmitting power of the base station for transmitting via DPCH changes dependent on traffic of communication thereof. Further, communication of MBMS occurs when a data transmission request is issued by a server (not shown) to provide the MBMS service, and transmitting power of the base station for transmitting MBMS data via SCCPCH changes dependent on traffic of communication thereof. Accordingly, the sum total of transmitting power of all channels in each cell is the sum of the transmitting power of DPCH, the transmitting power of SCCPCH and the transmitting power of CPICH in each cell, and this sum total of transmitting power is called “cell load”.

In addition, the transmitting power of DPCH and the transmitting power of SCCPCH may be defined by any method, but, here, assuming that the transmitting power of one DPCH is controlled to maintain constant quality of reception via DPCH in the mobile station, and the transmitting power of SCCPCH is a constant quantity defined in advance corresponding to each data transmission rate. Also, the cell load may be calculated based on, not limited to the transmitting power described above, a rate of transmitting power to an upper limit of transmitting power, the number of DPCH and SCCPCH during transmission, or the sum of a transmission rate of DPCH and a transmission rate of SCCPCH.

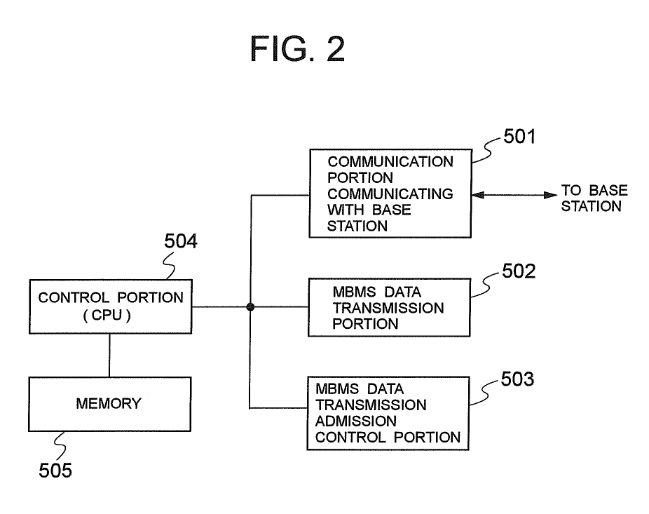

FIG. 2 is a schematic functional block diagram of RNC 5 in the present embodiment, and shows only a block associated with the present invention. Referring to FIG. 2, RNC 5 includes a communication portion 501 having communication function with the base stations 1 and 2, an MBMS data transmission portion 502 having MBMS data transmission function, an MBMS data transmission admission control portion 503 for performing admission control for MBMS data transmission, a control portion (CPU) 504 for controlling each of the portions, and a memory 505 operating as work RAM for the control portion 504 and ROM for storing control operation procedures of the control portion 504 in advance as a program.

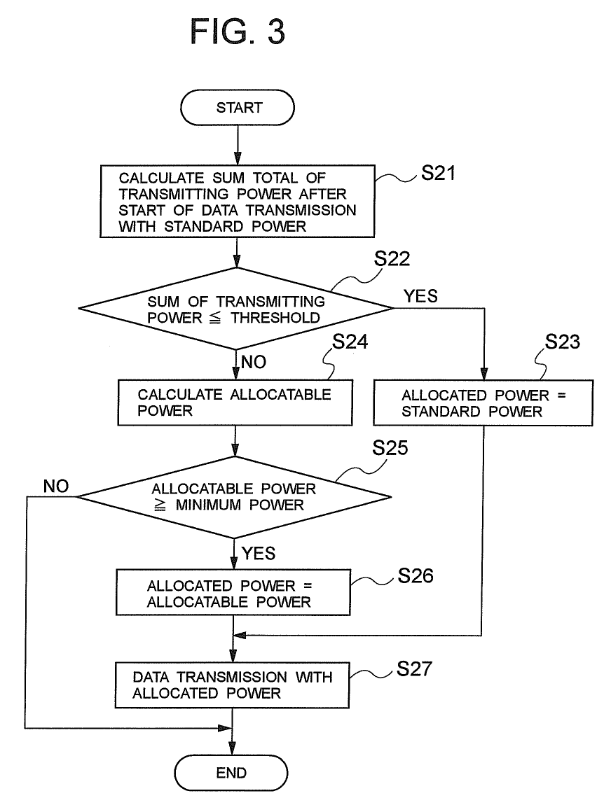

FIG. 3 is a flowchart illustrating operation in the present embodiment, and shows an example of MBMS data transmission procedures performed by RNC 5. Referring to FIG. 3, RNC 5, first, calculates the sum of transmitting power after the start of data transmission when data is transmitted via SCCPCH using standard power (step S21). The standard power is set in advance so that rate of a data receivable area in each cell meets a predetermined design reference value.

The sum of transmitting power increases proportionally to a rate at which transmitting power of common channels (CPICH, SCCPCH) increases due to starting data transmission in each cell at the same time as an adjacent cell, and therefore is calculated as follows.

$$P\_total = ( P\_cpich + P\_sccpch + P\_dpch ) \times \{ ( P\_cpich + P\_sccpch + Δ P\_sccpch \_std ) / ( P\_cpich + P\_sccpch ) \} \qquad ( 1 )$$

In the equation (1), P_total indicates the sum of transmitting power, P_cpich indicates transmitting power of CPICH, P_dpch indicates transmitting power of DPCH before addition of MBMS data transmission, P_sccpch indicates transmitting power of SCCPCH before addition of MBMS data transmission, and ΔP_sccpch_std indicates standard power for MBMS data transmission, respectively.

Then, when the sum of transmitting power does not exceed a predetermined threshold, allocated power is set to the standard power, and using the allocated power, data is transmitted (steps S22, S23, and S27). Further, when the sum of transmitting power exceeds the predetermined threshold, allocatable power is calculated (step S24). The allocatable power has a value defined so that the sum of transmitting power becomes equal to the threshold of the sum of transmitting power when data is transmitted by using the allocatable power, and is calculated as follows.

$$P\_th = ( P\_cpich + P\_sccpch + P\_dpch ) \times \{ ( P\_cpich + P\_sccpch + Δ P\_sccpch \_available ) / ( P\_cpich + P\_sccpch ) \} \qquad ( 2 )$$

In the equation (2), P_th indicates the threshold of the sum of transmitting power, and ΔP_sccpch_available indicates the allocatable power for MBMS data transmission, respectively.

From the equation (2), the allocatable power is obtained as follows.

$$Δ P\_sccpch \_available = P\_th \times ( P\_cpich + P\_sccpch ) / ( P\_cpich + P\_sccpch + P\_dpch ) - ( P\_cpich + P\_sccpch ) \qquad ( 3 )$$

When the allocatable power indicated by the equation (3) is equal to or greater than minimum power, the allocated power is set to the allocatable power, and using the allocated power, data is transmitted (steps S25, S26, and S27). Here, the minimum power is set in advance so that rate of a data receivable area in each cell where data is transmitted by using the minimum power meets a predetermined design reference value (for example, 50%). In addition, at step S25, when the allocatable power is smaller than the minimum power, data is not transmitted.

In this way, RNC 5 performs data transmission by using the standard power when the sum of transmitting power does not exceed the threshold even if transmitting data using the standard power, and when the sum of transmitting power exceeds the threshold, only when the allocated power is equal to or greater than the minimum power, RNC 5 performs data transmission by using the allocatable power in which the sum of transmitting power becomes equal to the threshold.

Next, a second exemplary embodiment of the present invention will be described. A cellular system in the present embodiment conforms to Long Term Evolution (LTE) Network studied by Third Generation Partnership Project (3GPP), which is the association for standardization of mobile communication system. In the present embodiment, instead of RNC 5 of the first exemplary embodiment, a gateway device (GW) 15 is provided, and base stations 11 and 12 are connected to GW 15. Also, the base stations 11 and 12 have function equivalent to that of RNC 5 of the first exemplary embodiment, and are called “eNodeB” in LTE. In addition, the rest are the same as the first exemplary embodiment, and a like portion to FIG. 1 is indicated by a like symbol.

In this cellular system, Orthogonal Frequency Division Multiple Access (OFDMA) system is used as a wireless access system of downlink, and a frequency band allocated to the cellular system is divided into a plurality of frequency bands (called RB: Resource Block), and each RB is assigned in a predetermined time frame for communication between the base station and the mobile station, and thereby many mobile stations can communicate through voice or packet in each cell.

The base station, upon transmitting data through each RB, may control transmitting power thereof, but, in the present embodiment, the transmitting power is constant, and transmitting power per information bit is changed by adaptively changing combination of a modulation system and a coding rate according to channel quality (MCS: Modulation and Coding Schemes), and thereby, using a predetermined radio resource, data can be transmitted at the maximal transmission rate. Therefore, when MBMS data is transmitted at a constant transmission rate, the number of RBs required per predetermined time frame is determined dependent on MCS used for the transmission.

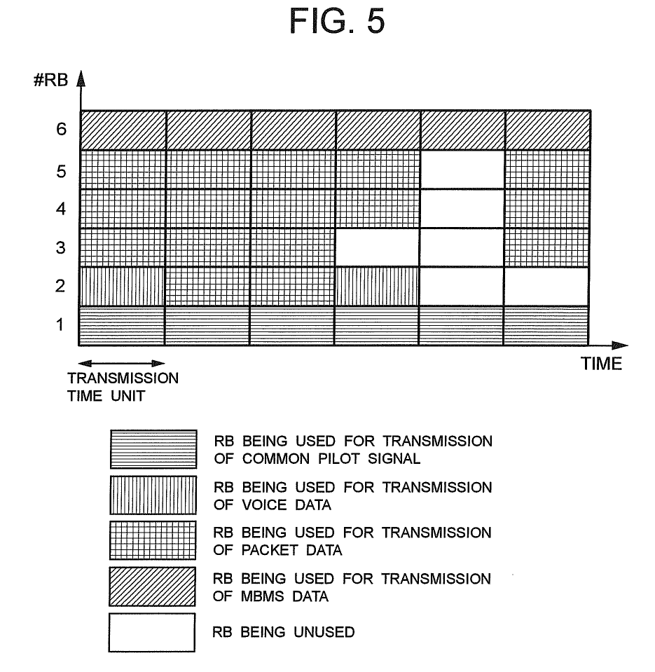

Each base station has a scheduler for determining RB assignment, and the scheduler determines RB assignment used for transmitting the voice data, the packet data and MBMS data for every transmission time frame. FIG. 5 shows one example of the assignment. FIG. 5 also shows RB for transmission of a common pilot channel via which a predetermined signal pattern is transmitted. This is used, for example, to determine the cell in which the mobile station communicates.

In FIG. 5, the longitudinal axis shows an RB number, and the horizontal axis shows time, and it is shown that a state of RB assignment is changed every transmission time frame. In addition, in FIG. 5, horizontal lines indicate RB being used for transmission of the common pilot channel, vertical lines indicate RB being used for transmission of voice data, a lattice pattern indicates RB being used for transmission of packet data, diagonal lines indicate RB being used for transmission of MBMS data, and a blank indicates RB being unused, respectively.

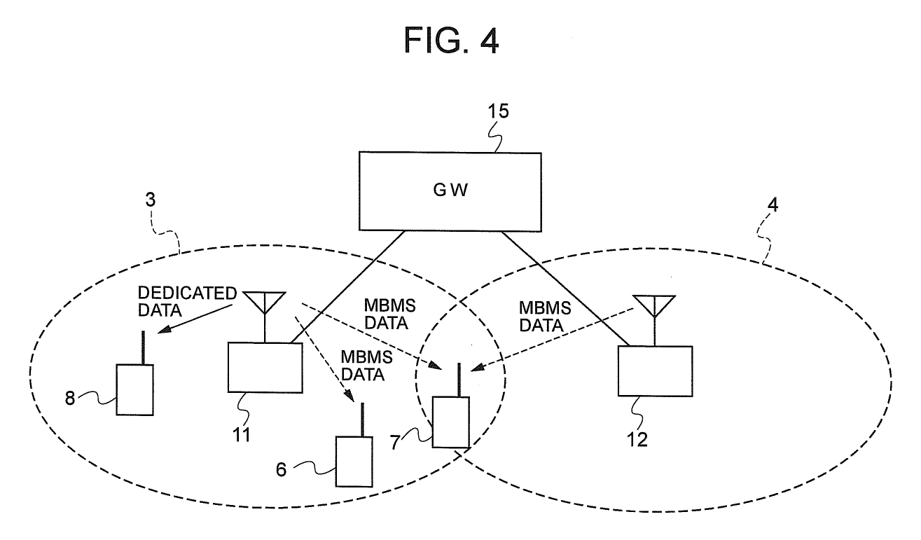

In the cellular system of FIG. 4, the base stations 11 and 12 provide dedicated data for the voice transmission service or the packet transmission service to the plurality of mobile stations in the cells 3 and 4, respectively, by using RB assigned by the scheduler, and transmit the same data (MBMS data) to the plurality of mobile stations by using a predetermined RB. In FIG. 4, assuming that the mobile stations 6 and 7 receive MBMS data, and the base station 8 receives the dedicated data. Assuming that the mobile station 7 receives MBMS data transmitted in the cell 3 of the base station 11 and in the cell 4 of the base station 12, and performs diversity combining.

When an MBMS data transmission request occurs, admission control is performed based on a resource consumption level of each cell to determine whether the data transmission is allowable or not. In the present embodiment, an average RB usage rate is used as the resource consumption level. The average RB usage rate is an RB usage rate within a constant time period for average until each time point (a rate of RBs being used to all RBs).

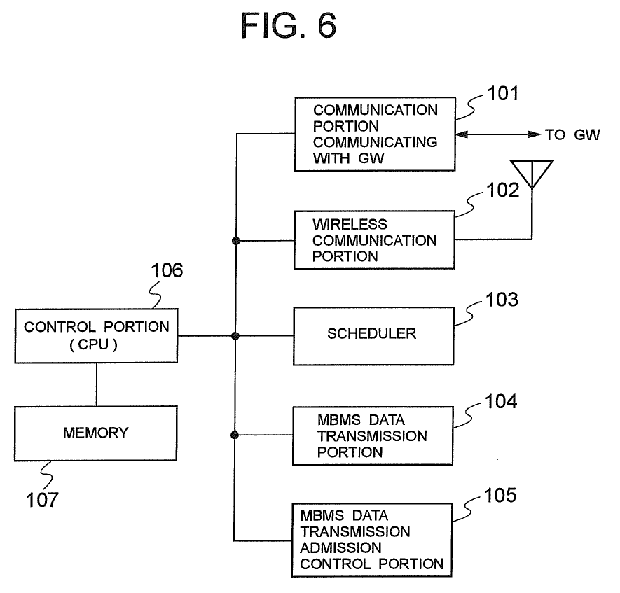

FIG. 6 is a schematic functional block diagram of the base stations 11 and 12 according to the present embodiment, and shows only a block associated with the present invention. Referring to FIG. 6, the base station includes a communication portion 101 having communication function with the GW 15, a wireless communication portion 102 having communication function with the mobile station, the scheduler 103 described above, an MBMS data transmission portion 104 having MBMS data transmission function, an MBMS data transmission admission control portion 105 for performing admission control for MBMS data transmission, a control portion (CPU) 106 for controlling each of the portions, and a memory 107 operating as work RAM for the control portion 106 and ROM for storing control operation procedures of the control portion 106 in advance as a program.

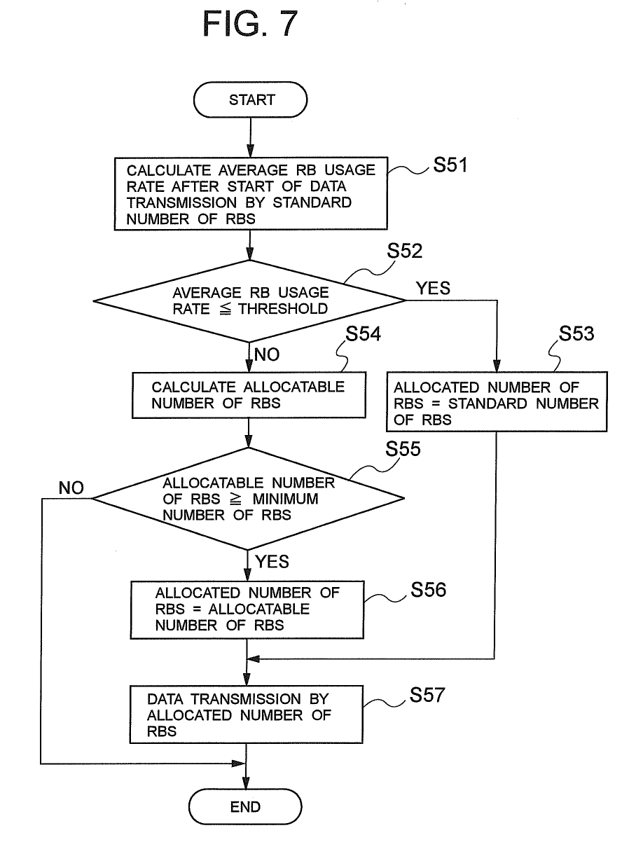

FIG. 7 is a flowchart illustrating MBMS data transmission procedures in the base station according to the present embodiment. Referring to FIG. 7, the base station, first, calculates the average RB usage rate after the start of data transmission when data is transmitted using standard MCS (step S51). The standard MCS is set in advance so that rate of a data receivable area in each cell meets a predetermined design reference value. The average RB usage rate after the start of data transmission using the standard MCS is calculated by adding a value to the last average RB usage rate, which value is obtained by dividing a standard number of RBs by the number of all RBs. The standard number of RBs is the number of RBs required to transmit MBMS data using the standard MCS.

Then, when an average number of RBs does not exceed a predetermined threshold, an allocated number of RBs is set to the standard number of RBs, and by the standard number of RBs, data is transmitted (steps S52, S53, and S57). Further, when the average number of RBs exceeds the predetermined threshold, an allocatable number of RBs is calculated (step S54). The allocatable number of RBs has a value defined so that the average number of RBs becomes equal to the threshold of the average number of RBs when data is transmitted by the allocatable number of RBs.

When the allocatable number of RBs is equal to or greater than a minimal number of RBs, the allocated number of RBs is set to the allocatable number of RBs, and by the allocated number of RBs, data is transmitted (steps S55 to S57). Here, the minimum number of RBs is set in advance so that, in the cell where data is transmitted using MCS corresponding to a high transmission rate to provide a predetermined data transmission rate by the minimum number of RBs, coverage of a data receivable area meets a predetermined design reference value (for example, 50%). In addition, at step S55, when the allocatable number of RBs is smaller than the minimal number of RBs, data is not transmitted.

In this way, the base station performs data transmission using the standard MCS in the case where the average number of RBs does not exceed the threshold even when data is transmitted using the standard MCS. Further, when the average number of RBs exceeds the threshold, only when the allocated number of RBs is equal to or greater than the minimal number of RBs, the base station performs data transmission by the allocatable number of RBs in which the average number of RBs becomes equal to the threshold.

As described above, because the resource consumption level upon data transmission becomes equal to the predetermined threshold of resource consumption level, blocking of the data transmission by the admission control is eliminated, and further data is transmitted using the resource to a maximum extent within the range of the threshold of resource consumption level, so that an area where the data is receivable is maximized.

Further, data is concurrently transmitted using the same radio frequency between the plurality of cells, and the mobile station receives data transmitted from the plurality of cells to perform diversity combining, and it becomes easy to transmit data, and therefore an improving effect of the quality of data reception can be easily provided due to the diversity combining, and an area where data is receivable is maximized.

Moreover, when a usable resource is smaller than a predetermined lower limit, data is not transmitted, and when enlargement of an area where data is receivable cannot be largely expected by using the usable resource, the resource is not wasted, and interfering power with another adjacent cell is reduced, and therefore the quality of data reception in another cell is improved and an area where data is receivable is maximized.

It is obvious that the operation procedures in the operational flow of each embodiment described above shown in FIG. 3 or 7 can be stored in a recording medium such as ROM in advance as a program, which is read out by CPU, which is a computer, to be executed.

An exemplary advantage according to the invention is that the resource consumption level turns out to be equal to the predetermined threshold of resource consumption level upon transmitting data, so that blocking of the data transmission by the admission control is eliminated, and data is transmitted using the resource to a maximum extent within the range of the threshold of resource consumption level, and therefore an area where the data is receivable is maximized.

Further, an exemplary advantage according to the invention is that data is concurrently transmitted using the same radio frequency between the plurality of cells, and the mobile station receives data transmitted from the plurality of cells to perform diversity combining, and it becomes easy to transmit data, so that an improving effect of the quality of data reception can be easily provided due to the diversity combining, and an area where data is receivable is maximized.

Moreover, an exemplary advantage according to the invention is that, when a usable resource is smaller than a predetermined lower limit, data is not transmitted, and when enlargement of an area where data is receivable cannot be largely expected by using the usable resource, the resource is not wasted, and interfering power with another adjacent cell is reduced, and therefore the quality of data reception in another cell is improved, and an area where data is receivable is maximized.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A method for transmitting data of a cellular system where, in each of a plurality of cells, a base station transmits the same data to a plurality of mobile stations at a predetermined transmission rate, the method comprising:
adjusting a resource used for data transmission to make a resource consumption level equal to a predetermined threshold when the resource consumption level in the cell exceeds the predetermined threshold due to the data transmission; and
performing the data transmission by using the adjusted resource.

2. The method for transmitting data according to claim 1, wherein
the data is concurrently transmitted using the same radio frequency between the plurality of cells.

3. The method for transmitting data according to claim 1, further comprising:
in the mobile station, performing diversity combining by receiving the data transmitted in the plurality of cells.

4. The method for transmitting data according to claim 1, wherein
in each of the plurality of cells, when the adjusted resource is smaller than a predetermined lower limit, the data is not transmitted.

5. The method for transmitting data according to claim 1, wherein
the resource consumption level is the sum total of transmitting power of the base station in the cell.

6. The method for transmitting data according to claim 1, wherein
the resource consumption level is a usage rate of a resource block used for transmitting one of a pilot signal and data.

7. A cellular system where, in each of a plurality of cells, a base station transmits the same data to a plurality of mobile stations at a predetermined transmission rate, the cellular system comprising;
an adjusting portion for adjusting a resource used for data transmission to make a resource consumption level equal to a predetermined threshold when the resource consumption level in the cell exceeds the predetermined threshold due to the data transmission; and
a transmitting portion for performing the data transmission by using the adjusted resource.

8. The cellular system according to claim 7, wherein
the data is concurrently transmitted using the same radio frequency between the plurality of cells.

9. The cellular system according to claim 7, wherein
the mobile station performs diversity combining by receiving the data transmitted in the plurality of cells.

10. The cellular system according to claim 7, wherein
in each of the plurality of cells, when the adjusted resource is smaller than a predetermined lower limit, the data is not transmitted.

11. The cellular system according to claim 7, wherein
the resource consumption level is the sum total of transmitting power of the base station in the cell.

12. The cellular system according to claim 7, wherein
the resource consumption level is a usage rate of a resource block used for transmitting one of a pilot signal and data.

13. A storage medium storing a program for executing a method for transmitting data of a cellular system on a computer, wherein, in each of a plurality of cells, a base station transmits the same data to a plurality of mobile stations at a predetermined transmission rate, the program comprising;
a process of adjusting a resource used for data transmission to make a resource consumption level equal to a predetermined threshold when the resource consumption level in the cell exceeds the predetermined threshold due to the data transmission; and
a process of performing the data transmission by using the adjusted resource.

14. A cellular system where, in each of a plurality of cells, a base station transmits the same data to a plurality of mobile stations at a predetermined transmission rate, the cellular system comprising;
means for adjusting a resource used for data transmission to make a resource consumption level equal to a predetermined threshold when the resource consumption level in the cell exceeds the predetermined threshold due to the data transmission; and
means for performing the data transmission by using the adjusted resource.
